(19) United States
(12) Patent Application Publication
(10) Pub. No.: US 2025/0109299 A1
(43) Pub. Date: Apr. 3, 2025

(54) PIGMENTED INK RECEIVING LAYER FOR DECORATIVE BUILDING BOARDS

(71) Applicant: HEUBACH HOLDING SWITZERLAND LTD, Pratteln (CH)

(72) Inventors: Chen LIU, Shanghai (CN); Qinbo XIAO, Shanghai (CN); Jianping WANG, Tianjin (CN)

(21) Appl. No.: 18/834,479

(22) PCT Filed: Jan. 31, 2022
(86) PCT No.: PCT/CN2022/075281

§ 371 Date: Jul. 30, 2024

(51) Int. Cl. C09D 5/00; C09D 7/42; C09D 7/61; C09D 133/08

(52) U.S. Cl. CPC C09D 5/002; C09D 7/42; C09D 7/61; C09D 133/08

(57) ABSTRACT

The invention concerns a method for the preparation of a coated building board comprising an ink receiving layer, the method comprising at least i) application of an aqueous coating composition comprising a) 5 to 40% by weight of the coating composition of an acrylic polymer, b) 1 to 6% by weight of the coating composition of a molecular sieve, and c) 1 to 30% by weight of the coating composition of a pigment, on at least a part of the surface of the building board, and ii) curing the coating composition. The invention also concerns the aqueous composition for preparing the ink receiving layer comprising the acrylic polymer, the molecular sieve and the pigment, and its use.

### TECHNICAL FIELD

The invention relates to a pigmented ink receiving layer for water-based ink for the preparation of decorative building boards, and a method for the preparation of coated building boards comprising the pigmented ink receiving layer. More specifically, the invention relates to aqueous coating compositions for the preparation of the coated building boards containing an acrylic polymer, a molecular sieve and a pigment.

### BACKGROUND OF THE INVENTION

Coloured patterns can be applied on various types of decorative building boards by inkjet printing, for example, which allows efficient production and individual design. Compared with solvent based ink and UV ink, water-based ink has attracted more attention, because pigments with higher weather durability can be applied, which are suitable for external wall application. A further important advantage is that water-based inks are more environment-friendly.

On the other hand, performing waterborne inkjet printing is challenging, because water-based ink is hard to cure compared with solvent ink or UV ink. Water-based ink therefore tends to penetrate into the base material, particularly if the base material is porous, or to spread on the surface if the base material is non-porous. This leads to images with low quality.

To improve the colour strength of images printed with water-based inks on decorative building boards JP 2007154433 suggests an ink receiving layer fixed on the surface of the building board. The ink-receiving layer is a water-based paint comprising an extender pigment and a hygroscopic resin. JP 2007167826 describes the use of such coating composition to decrease ink consumption for inkjet printing. To suppress the permeation of ink into an ink receiving layer and to stably fix ink an ink receiving layer comprising polysiloxane is suggested in JP 2015051549.

JP 2008273055 discloses a coating composition for ink receiving layers comprising 20 to 80 weight % of the solid content of the coating composition of a mica filler to enhance durability of the coating layer.

JP 2008063832 provides a decorative building board enhancing ink fixability to an ink receiving layer and preventing strength degradation of the layer. To achieve the desired effects the ink receiving layer comprises filler with a high aspect ratio of 3 to 70, which can be finely split on the surface of the layer.

The coated building board usually comprise a sealing layer and a coloured primer layer on the surface of the building board. Thus, the surface of the building board on which the aqueous coating composition is being applied is formed by such a primer layer. A primer layer is used to provide background colour, particularly if a colour imaging layer without pigments is applied afterwards. Building boards usually comprise a sealing layer and a white primer layer.

The problem to be solved by the present invention is to provide building boards which can be used as base material for high quality images printed with water-based inkjet ink. In particular the resolution of the printed images, the colour strength and the stability of the images shall be improved. To achieve these goals, the penetration of water-based ink into the building board shall be reduced to avoid low colour strength, and colour bleeding shall be avoided to achieve improved resolution of the printed patterns.

In general, the production process for the coated building boards comprises steps (1) to (10) as follows:
(1) Spray coating the sealing layer;
(2) Drying the sealing layer;
(3) Spray coating the coloured primer layer;
(4) Drying the primer layer;
(5) Spray coating the ink receiving layer;
(6) Drying the ink receiving layer;
(7) Inkjet printing;
(8) Drying;
(9) Spray coating the top coat layer;
(10) Drying the top coat layer.

For practical reasons (limited number of spray rooms and spray coat machines), quite often between step (4) and (5) the pre-coated building boards must be removed from the production line, set aside (stapled), and the spray coating machine must be loaded with the ink receiving layer coating composition, followed by further processing of the stapled pre-coated building boards, which involves a number of additional process steps. It is also an object of the present invention to simplify this production process.

### DESCRIPTION OF THE INVENTION

The problem is solved by an ink receiving layer (colour imaging layer) comprising an acrylic polymer, a molecular sieve and a pigment.

More specifically, the problem is solved by a method for the preparation of a coated building board comprising an ink receiving layer (colour imaging layer), wherein the method comprises at least:
i) application of an aqueous coating composition comprising
   a) 5 to 40% by weight of the coating composition of an acrylic polymer,
   b) 1 to 6% by weight of the coating composition of a molecular sieve, and
   c) 1 to 30% by weight of the coating composition of a pigment, on at least a part of the surface of the building board, and
ii) curing the coating composition.

The problem is also solved by an aqueous coating composition comprising
a) 5 to 40% by weight of the coating composition of an acrylic polymer,
b) 1 to 6% by weight of the coating composition of a molecular sieve, and
c) 1 to 30% by weight of the coating composition of a pigment.

Preferably, the surface of the building board on which the aqueous coating composition is applied does not contain a coloured primer layer.

However, the surface of the building board on which the aqueous coating composition is applied preferably contains a sealing layer.

By including a pigment into the ink receiving layer, a coloured primer layer is unnecessary, and the production process is simplified, as follows:
(1) Spray coating the sealing layer;
(2) Drying the sealing layer;
(3) Spray coating the ink receiving layer;
(4) Drying the ink receiving layer;
(5) Inkjet printing;
(6) Drying;
(7) Spray coating the top coat layer;
(8) Drying the top coat layer.

Furthermore, no additional process steps of removing pre-coated building boards from the production line and setting them aside, reloading the spray coating machine with a further coating composition, and re-equipping the production line with the pre-coated boards for further processing will be necessary. Hence, a much simpler production process results.

The coated building boards of the present invention are obtained by an aqueous coating composition comprising an acrylic polymer emulsion, a molecular sieve and a pigment, which can be cured at the surface of the building board.

The aqueous coating compositions of the invention comprises an acrylic polymer emulsion. The acrylic emulsion comprises an acrylic polymer a) obtainable by free radical polymerization of an acrylic monomer composition, wherein the acrylic monomers are selected from the group consisting of acrylate, methacrylate, alkyl acrylate, alkyl methacrylate, hydroxyalkyl acrylate, hydroxyalkyl methacrylate, epoxyalkyl acrylate, epoxyalkyl methacrylate, acrylonitrile, methacrylonitrile, acrylamide, methacrylamide, acrylic acid and mixtures thereof and optionally ethylenically unsaturated comonomers.

Preferred acrylic polymers a) derive from monomers of the group consisting of acrylate, methacrylate, (C₁-C₄)-alkyl acrylate, (C₁-C₄)-alkyl methacrylate, acrylic acid and mixtures thereof and optionally ethylenically unsaturated comonomers.

Preferred comonomers are selected from the group of (C1-C6)-alkylene, particularly ethylene, propylene and butylene, and styrene.

The acrylic polymer emulsions include also emulsions of acrylic silicone resins.

The acrylic monomer composition comprises preferably at least 50% by weight acrylic monomers and less than 50% by weight of ethylenically unsaturated comonomers.

The content of the solid acrylic polymer a) in the acrylic emulsion is in general the range of from 20 to 75% by weight, preferably from 30 and 70% by weight, particularly preferred from 30 to 60% by weight.

The water content of the acrylic polymer emulsion is general from 25 and 80% by weight, preferably from 30 and 70% by weight, particularly preferred from 40 to 70% by weight.

The aqueous coating compositions of the invention further comprise a molecular sieve b).

A molecular sieve is a porous material with pores of relatively uniform size. The pore diameters of molecular sieves are similar in size to small molecules, and thus large molecules cannot be adsorbed in contrary to smaller molecules, such as water for example. The diameter of a molecular sieve is measured in ångströms (Å) or nanometres (nm). Molecular sieves are classified in microporous materials having pore diameters of less than 2 nm (20 Å), mesoporous materials with pore diameters between 2 and 50 nm (20-500 Å) and macroporous materials having pore diameters of greater than 50 nm (500 Å). Macroporous materials having a pore size of more than 200 nm (2000 Å) are not regarded as molecular sieves within the meaning of the present invention.

To achieve the desired effects of the invention the use of microporous molecular sieves is preferred. Preferred molecular sieves b) have a narrow pore size distribution, wherein at least 90% of the pores of the molecular sieve have pore diameters between 0.1 nm to 2 nm, more preferably between 0.2 nm to 0.8 nm.

Microporous molecular sieves can be selected for example from the group of aluminosilicate minerals (zeolites), phosphorous modified small-pore zeolites, porous glasses, activated carbon, and small-porous clays, such as montmorillonite.

Preferred molecular sieves b) are able to adsorb molecules having an effective diameter of 0.5 nm or smaller, such as water. Useful sieves are able to adsorb at least 5 wt.-% of water, more favourably more than 10 wt.-% of water at 20° C. compared to the weight of the molecular sieve.

Preferred microporous molecular sieves are selected from the group of zeolites. Particularly preferred are 3 Å, 4 Å or 5 Å zeolites.

Suitable zeolites have the general formula (I)

Mⁿ⁺_{x/n}·[(AlO₂)⁻ₓ·(SiO₂)_{y}]·zH₂O (I)
wherein
n is 1, 2, 3 or 4, preferably n is 1 or 2;
M is selected from the group of monovalent, divalent, trivalent or tetravalent metals or mixtures thereof, preferably M is selected from the group of alkali metals, alkaline earth metals and mixtures thereof, wherein metals of the group of potassium, sodium, magnesium, and calcium are most preferred;
x is between 1 and 10, preferably between 1 and 3 and
the ratio x/y of the zeolites of formula (I) is between 1 and 5, more preferably between 1 and 3 and most preferably the ratio is approx. 2, that means between 1.8 and 2.2.

The water content of the zeolites can vary in a wide range. For example, water can be removed from the zeolites by heating without the destruction of the structure of the zeolites. Vice versa zeolites can absorb water until the capacity of the compound is exhausted. Dried zeolites of the preferred zeolite type (x and x/y is in the range of 1 to 3), for example, are able to adsorb up to 30% by weight of water compared to the weight of the zeolite. The water content z of the zeolites of formula (I) is typically in the range of from 0 to 50, preferably between 1 and 30. For preferred zeolites, wherein x is in the range of 1 to 3 and the x/y ratio is in the range of 1 to 3, z is typically less than 10.

Most preferred molecular sieves b) of the zeolite type are 3 Å, 4 Å or 5 Å zeolite sieves.

Typical 3 Å sieves have the chemical formula

x′K₂O·x″Na₂O·Al₂O₃·ySiO₂·zH₂O
wherein
x′ and x″ are in the range of 0.3 to 0.7, and x′+x″ is 1;
y is in the range of 1.8 to 2.2, preferably y is 2, and
z is less than 8, z is preferably in the range of 3 to 6, typically 4.5.

Typical 4 Å sieves have the chemical formula

Na₂O·Al₂O₃·ySiO₂·zH₂O
wherein
y is in the range of 1.8 to 2.2, preferably y is 2, and
Z is less than 8, z is preferably in the range of 3 to 6, typically 4.5.

Typical 5 Å sieves have the chemical formula

x′CaO·x″Na₂O·Al₂O₃·ySiO₂·zH₂O
wherein
x′ is in the range of 0.6 to 0.8,
x″ is in the range of 0.2 to 0.4, and
x′+x″ is 1;
y is in the range of 1.8 to 2.2, preferably y is 2, and
Z is less than 8, z is preferably in the range of 3 to 6, typically 4.5.

A broad variety of microporous molecular sieves including 3 Å, 4 Å and 5 Å zeolites are commercially available. However, 4 Å sieves can be prepared by mixing aqueous solutions of sodium silicate and sodium aluminate at 80° C. Then the sieve is activated by baking at 400° C. 3 Å and 5 Å sieves can be prepared through cation exchange of sodium for potassium (for 3 Å sieves) or sodium for calcium (for 5 Å sieves) starting from a 4 Å sieve.

A mesoporous molecular sieve is for example silicon dioxide. Examples for macroporous molecular sieves are porous silica compounds with pore diameters of 200-1000 Å.

The pore size of molecular sieves is depending on the size of the lattice of the material itself, and it is mainly determined by the size of cationic ions. The structure of a broad variety of zeolites including the size of the channels (pores) is summarized in “Atlas of Zeolite Framework Types” (Baerlocher et al., Elsevier, Sixth Revised Edition, 2007).

Preferred molecular sieves b) are able to adsorb molecules having an effective diameter of 0.5 nm or less, such as for example water. Useful sieves are able to adsorb at least 5 wt.-% of water, more favourably more than 10 wt.-% of water compared to the weight of the molecular sieve.

The molecular sieve is preferably applied in powder from to the aqueous coating composition. Preferred powders have an average particle diameter in the range of 0.1 μm to 250 μm, preferable the average diameter is between 1 μm and 50 μm. The average diameter of at least 80% of the particles, particularly at least 90%, should be fall within the range.

The size distribution of molecular sieve particles can be determined by laser diffraction analysis. The mean diameters can be determined by laser light scattering, for example by using a Horiba LA 940 or Mastersizer 3000 from Malvern using the “Mie Scattering Theory” evaluation. In case of particles having axes of different length, such a particle having the shape of an ellipsoid or of a disk, the largest axis determines the mean diameter. The particles of the present invention have preferably a narrow particle size distribution of Gaussian shape. Preferably the standard deviation of the particle size distribution is between 10% and 120% of the mean diameter. More preferably the standard deviation is between 20% and 90%.

The aqueous coating composition comprises preferably from 2 to 6% by weight, more preferably from 2 to 5.5% by weight and in particular from 3 to 5% by weight of the molecular sieve. The amount of the acrylic polymer (solid content) is preferably in the range of from 10 to 35% by weight, more preferably in the range of from 10 to 30% by weight and in particular in the range of from 15 to 30% by weight, based on the total weight of the aqueous coating composition.

The aqueous coating compositions of the invention further comprise pigments c). The pigments can be selected from inorganic pigments or organic pigments. Pigments which may be used are all pigments known to the person skilled in the art for emulsion paints. Preferred pigments are titanium dioxide, preferably in the form of rutile, barium sulfate, zinc oxide, zinc sulfide, basic lead carbonate, antimony trioxide and lithopone (zinc sulfide and barium sulfate). However, the aqueous preparations may also contain coloured pigments, for example iron oxides, carbon black, graphite, luminescent pigments, zinc yellow, zinc green, ultramarine, manganese black, antimony black or manganese violet. Organic pigments are, for example, azo dyes, quinacridone, phthalocyanine, isoindolinone, sepia, gamboge, indigo, anthraquinoid and indigoid dyes and dioxazine, and metal complex pigments.

The most preferred pigments are titanium dioxide, zinc oxide, zinc sulphide, barium sulfate, lead white (lead hydroxycarbonate, 2PbCO₃·Pb(OH)₂), antimony white (antimony (III) oxide, Sb₂O₃), calcium carbonate (chalk) and lithopone. Particularly preferred is titanium dioxide.

The pigments are added to the aqueous coating composition in an amount of from 1 to 30% by weight, preferably from 2.5 to 25% by weight, more preferably from 5 to 25% by weight, based on the total weight of the aqueous coating composition.

The aqueous coating composition may comprise optional additives. Examples for useful additives are defoamer, dispersants, wetting agents, thickener, film-former, matting agents, neutralizer, biocides and humectants. The additives may be applied to the acrylic polymer emulsion or to the aqueous coating composition comprising the emulsion.

Customary additives include defoaming additives d), for example fatty acid alkyl ester alkoxylates, silicone oils, organopolysiloxanes, such as polydimethylsiloxanes, polyether modified polysiloxanes, silanized silica, paraffins, including paraffin oils, polyether, such as polyethylene glycol, polypropylene glycol or EO/PO copolymers, and mixtures thereof.

Defoaming additives d) are for example fatty acid alkyl ester alkoxylates, silicone oils, organopolysiloxanes, such as polydimethylsiloxanes, polyether modified polysiloxanes, silanized silica, paraffins, including paraffin oils, polyether, such as polyethylene glycol, polypropylene glycol or EO/PO copolymers, alkyne glycol, such as acetylenic diol, and mixtures thereof.

Defoamers d) are typically used in an amount of from 0.1 to 2% by weight, based on the total amount of the aqueous coating composition.

Customary additives further include dispersants or wetting agents e), such as sodium, potassium, or ammonium polyphosphates, alkali metal salts or ammonium salts of polyacrylic acids and of polymaleic acid, styrene maleic anhydride copolymers, polyphosphonates, amino alcohols, such as, for example, 2-amino-2-methylpropanol. The dispersants or wetting agents are preferably used in an amount of up to 2% by weight, based on the total weight of the aqueous coating composition.

Usually the acrylic polymer of the acrylic polymer emulsion is self-emulsifiable. Thus, the amount of additional dispersants can be low. The content of dispersants in the aqueous coating composition is typically from 0.1 to 2% by weight, preferably in the range of from 0.1 to 1% by weight, based on the total weight of the aqueous coating composition.

Matting agents f) may be present in the aqueous coating composition in an amount of from 0.1 to 15% by weight, based on the total weight of the coating composition. Preferred is a content of matting agents of from 2 to 15% by weight. Suitable matting agents are silicon dioxide, waxes and polysaccharides, like cellulose.

Preferred aqueous coating composition comprise one or more matting agents f). Preferably, the matting agent comprises at least one of silicon dioxide and a polysaccharide, like cellulose, in particular both of them.

Suitable film-former g) are for example polyvinylpyrollidone, glycol ethers or glycol esters or combinations thereof. Examples for glycol ethers are ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monohexyl ether, diethylene glycol monomethyl ether, diethylene glycol monoethylether, diethylene glycol mono-n-butyl ether, diethylene glycol mono-n-hexyl ether, propylene glycol monomethyl ether, propylene glycol monoethyl ether, propylene glycol monobutyl ether, propylene glycol monohexyl ether, polyethylene glycol ether, polypropylene glycol ether, ethylene glycol dimethyl ether, ethylene glycol diethyl ether, and ethylene glycol dibutyl ether. Glycol esters are for example ethylene glycol methyl ether acetate, ethylene glycol monoethyl ether acetate, ethylene glycol monobutyl ether acetate, and propylene glycol methyl ether acetate.

The content of film-forming additives g) is typically from 0.1 to 10% by weight, based on the total amount of the aqueous coating composition. An amount in the range of from 0.5 to 5% by weight is preferred.

Preferred aqueous coating compositions comprise one or more film former g).

Thickeners h) which may be employed in the aqueous coating composition are for example cellulose derivatives, such as methylcellulose, hydroxyethylcellulose and carboxymethylcellulose, furthermore casein, gum arabic, starch, sodium alginate, polyvinyl alcohol, polyvinylpyrrolidone, styrene/maleic anhydride polymers polyetherurethanes, which can be hydrophically modified, hydrophobically modified acrylic acid copolymers (HASE), sodium polyacrylates, organosilicones, and polyetherpolyols.

Water-soluble copolymers based on acrylic and (meth)acrylic acid, such as acrylic acid/acrylamide and (meth)acrylic acid/acrylic ester copolymers have also thickening properties and are suitable.

Inorganic thickeners, such as, for example, bentonites, may also be used.

The use of thickeners of the group of acrylic polymers and polyurethanes is particularly favoured.

The amount of thickener h) based on the total weight of the coating composition is typically from 0.1 to 2% by weight.

Customary additives are furthermore biocides i). Suitable biocides are for example 5-chloro-2-methyl-4-isothiazoline-3-one, 2-methyl-4-isothiazolin-3-one and Bromopol (2-bromo-2-nitro-1,3-propanediol, CAS-No.: 52-51-7). Biocides are in general present in an amount of from 0.05 to 1% by weight, preferably from 0.05 to 0.5% by weight.

For some applications an adjustment of the pH-value of the aqueous coating composition is desired. To adjust the pH-value common neutralizers j) can be used. Examples for neutralizers are sodium hydroxide, potassium hydroxide, or amine derivatives. For most applications a pH-value in the range of 7 to 11 is desired. The neutralizer is added to the coating composition until the desired pH-value is achieved. Neutralizer are typically present in an amount of from 0.05 to 1% by weight.

The aqueous coating composition optionally comprises one or more humectants k). The humectants may be part of an additive composition. The amount of humectants is typically from 0.1 to 5% by weight, preferably from 0.5 to 5% by weight, based on the total weight of the coating composition.

Suitable are water miscible humectants, for example methanol, ethanol, propanol, butanol, benzyl alcohol, ethylene glycol, di-ethylene glycol, propylene glycol, di-propylene glycol, glycerol, polyethylene glycol, polypropylene glycol, and monomethyl ether or di-methyl ether of ethylene glycol or propylene glycol.

Preferred aqueous coating compositions comprise one or more humectants k), for example 1,2-propanediol.

Particularly preferred aqueous coating compositions comprise, in addition to the acrylic polymer a), the molecular sieve b) and the pigment c), at least a matting agent e), at least on film former g) and at least one humectant k), preferably in the amounts specified above.

The molecular sieve can be added to the acrylic polymer emulsion to obtain the aqueous coating composition. The molecular sieve can be simply incorporated into the acrylic polymer emulsion by stirring until the sieve is fully dispersed. Additives and pigments can be added, usually step by step, under stirring.

Beside the water that is already present in the acrylic polymer emulsion, additional water can be added to the aqueous coating composition, if appropriate. However, the overall content of water in the coating composition should not be more than 75% by weight and is in general 30 to 75% by weight. Preferably the overall water content of the aqueous coating composition of the invention is in the range of from 35 to 65% by weight, in particular of from 40 to 60% by weight.

In general, the aqueous coating compositions of the invention comprise
a) 5 to 40% by weight of an acrylic polymer,
b) 1 to 6% by weight of a molecular sieve,
c) 1 to 30% by weight of a pigment,
d) optionally 0 to 2% by weight of a defoamer,
e) optionally 0 to 2% by weight of a dispersant or wetting agent,
f) optionally 0 to 15% by weight of a matting agent,
g) optionally 0 to 10% by weight of a film former,
h) optionally 0 to 2% by weight of a thickener,
i) optionally 0 to 1% by weight of a biocide,
j) optionally 0 to 1% by weight of a neutralizer, and
k) optionally 0 to 5% by weight of a humectant.

Preferred aqueous coating compositions of the invention comprise
a) 10 to 35% by weight of an acrylic polymer,
b) 2 to 5.5% by weight of a molecular sieve,
c) 2.5 to 25% by weight of a pigment,
d) 0.1 to 2% by weight of a defoamer,
e) 0.1 to 2% by weight of a dispersant or wetting agent,
f) 0.1 to 15% by weight of a matting agent,
g) 0.1 to 10% by weight of a film former,
h) 0.1 to 2% by weight of a thickener,
i) 0.05 to 1% by weight of a biozide,
j) 0.05 to 1% by weight of a neutralizer, and
k) 0.1 to 5% by weight of a humectant.

Particularly preferred aqueous coating compositions of the invention comprise
a) 10 to 30% by weight of an acrylic polymer,
b) 2 to 5% by weight of a molecular sieve,
c) 5 to 25% by weight of a pigment,
d) 0.1 to 1% by weight of a defoamer,
e) 0.1 to 1% by weight of a dispersant or wetting agent,
f) 2 to 15% by weight of a matting agent,
g) 0.5 to 5% by weight of a film former,
h) 0.1 to 2% by weight of a thickener,
i) 0.05 to 0.5% by weight of a biocide,
j) 0.05 to 1% by weight of a neutralizer, and
k) 0.5 to 5% by weight of a humectant.

The aqueous coating composition can be applied to the surface of the building board by spray devices, such as a spry gun, for example. Alternatively, the coating composition can be brushed on the surface or applied with a doctor blade.

Typically the aqueous coating composition is applied in an amount of 10 g/m² to 300 g/m², preferably in the range of 20 g/m² to 200 g/m².

The aqueous coating composition applied to the building board is then cured to obtain a colour imaging layer (ink receiving layer) on the surface of the building board. Curing can be achieved by drying the coating at a temperature between 70° C. and 300° C. for 1 minute to 1 hour. The coating is dry enough, if the resulting colour imaging layer is able to capture water-based inks. The coated building boards may be dried in an oven. Drying at a temperature between 150° C. and 250° C. in 2 to 150 minutes is preferred.

The thickness of the colour imaging layer on the building board is usually between 5 μm and 500 μm, preferably between 10 μm and 200 μm.

A brought range of constructions materials can be used as building boards, as long as the colour imaging layer can be sufficiently fixed on the surface. For example, cement plates, gypsum plates, ceramic plates, metal plates, wooden plates or polymer resin plates are suitable building boards. Preferably, a building board made from cement or gypsum is used. The adhesiveness of the colour imaging layer is excellent on these boards. Suitable are also fibre-reinforced building boards, particularly cement boards comprising glass fibres or polymer fibres.

The coated building board comprises preferably a sealing layer. The sealing layer can be applied on the surface of the building board. Thus, the surface of the building board to which the aqueous coating composition is applied, is formed by such a layer. Typical sealers are water based or solvent-based acrylic resins, epoxy/urethane systems, silanes, silicates, siliconates, siloxanes etc.

A further embodiment of the present invention is a coated building board comprising a colour imaging layer (ink receiving layer) of a cured coating composition as described above.

The coated building board is particularly useful for printing coloured patterns or images on the colour imaging layer with water-based ink. The water-based ink can be directly printed onto the colour imaging layer, for example by inkjet printing. The printed patterns can be easily individualized. The coated building boards are suitable for DIY (do it yourself) printing.

If a water-based ink is applied to the colour imaging layer, the ink is fixed quickly, colour bleeding is significantly reduced. The resolution of the printed pattern or image is improved. Additionally, fast penetration of the water-based ink into the colour imaging layer is avoided, contributing to high colour strength.

Without bound to any theory, the desired effects are achieved by an accelerated water adsorption from the water-based ink by the molecular sieve and simultaneously penetration of the colorants and pigments, provided as components of the water-based inks, into the colour imaging layer is significantly retarded. This leads to low colour bleeding and high colour strength.

The colour imaging layer is particularly useful for applying water-based inks with a water content of 40-70 wt.-% and a pigment content in the range of from 0.1 to 20 wt.-%. Typical water-based inks comprise further up to 40 wt.-% of a humectant, such as glycerine, propylene glycol etc., up to 30 wt.-% of a surfactant, such as polyoxyethylene alkyl ether, and a pH regulator. Optionally the water-based ink can comprise up to 20 wt.-% of an acrylic resin.

Thus, a further embodiment of the present invention is the use of a building board comprising a colour imaging layer as described herein as base material for inkjet printing with water-based inks.

The invention also concerns the coated building board comprising a colour imaging layer of a cured coating composition as described herein on at least a part of the surface of the building board. Preferably, the building board is a cement plate, gypsum plate, ceramic plate, metal plate, wooden plate, polymer resin plate, calcium silicate plate, diatomite plate and polystyrene plate.

The invention also concerns the use of an aqueous coating composition as described herein for preparing a colour imaging layer (ink receiving layer) on a coated building board used as base material for inkjet printing with water-based ink. Preferably, and most advantageously, the aqueous coating composition is applied to a surface of the building board not containing a coloured primer layer.

### EXAMPLES

### Examples 1 to 5

The components used for preparing the compositions of Examples 1 to 5 are summarized in Table 1 below.

TABLE 1

| | | Type of |
|---|---|---|
| Components | Chemical Characterization | Component |
| Deionized Water | | Solvent |
| Mowilith ® DN 7070 | Water-borne Copolymerisate Dispersion | Binder |
| | plasticizer free, based on (Meth) Acrylic | |
| | acid esters | |
| TEGO ® FOAMEX 810 | Octamethyl cyclotetrasiloxane, | Defoamer |
| | CAS-No.: 556-67-2 | |
| BYK 022 | Mixture of foam destroying polysiloxanes | Defoamer |
| | and hydrophobic solids in polyglycol | |
| Surfynol DF-110D | Acetylenic Diol | Defoamer |
| BYK 028 | Oxirane, Me, polymer with oxirane monobutyl | Defoamer |
| | ether (polyalkylene glycol) | |
| DISPERBYK-190 | Solution of a high molecular weight block | Dispersant |
| | copolymer with pigment affinic groups | |
| AMP-95 ™ | 2-Amino-2-methyl-1-propanol, | Neutralizing agent |
| | CAS-No.: 124-68-5 | |
| ACEMATT ® TS 100 | Silicon dioxide | Matting |
| SYLOSIV ® A 3 | Zeolite | Absorber |
| SYLOID ® W 300 | Silicon dioxide | Matting |
| Ceridust ® 8090 VITA | Polysaccharide polymer, | Matting |
| | CAS-No.: 9004-34-6 | |
| DPnB | Di(propylene glycol) butyl ether, mixture of | Film-former |
| | isomers | |
| ACTICIDE ® LA 0614 | 5-chloro-2-methyl-4-isothiazoline-3-one, | Biocide |
| | 2-methyl-4-isothiazolin-3-one, Bronopol. | |
| TT615 | Acrylic based alkali soluble emulsion thickener | Thickener |
| Mowiplus TK-582 | Acrylic copolymer | Thickener |
| Colanyl White TQ 100-CN | Titanium dioxide dispersion | Pigment |
| 1,2-Propanediol | CAS-No.: 57-55-6 | Humectant |

### Example 1

30.1 parts by weight of acrylic emulsion (Mowilith DN 7070, from Archroma Co. Ltd.), 15 parts by weight of titanium dioxide (Colanyl White TQ-CN, from Clariant Chemicals Ltd), 0.15 parts by weight of defoamer (TEGO FOAMEX 810)), 1.35 parts by weight of humectant (1,2-propandiol), 1.13 parts by weight of silicon dioxide (ACEMATT TS 100; matting agent), 4.72 parts by weight of molecular sieve (SYLOSIV A 3 from W.R. Grace & Co.), 2.71 parts by weight of wax powder (Ceridust 8090 VITA from Clariant Chemicals Ltd; matting agent), 5.83 parts by weight of silicon dioxide (SYLOID W 300 from W.R. Grace & Co; matting agent) and 1.85 parts by weight of dionized water were mixed by a disperser at a shearing rate at 1300 rpm for 60 min,

Then 15.05 parts by weight of acrylic emulsion (Mowilith DN 7070, from Archroma Co. Ltd.), the mixture of 18.05 parts by weight of deionized water and 2.26 parts by weight of film-former dipropyleneglycol n-butylether (DPnB from Dow Chemical), 0.15 parts by weight of defoamer (Surfynol DF-110D from Evonik), 0.20 parts by weight of biocide (Acticide LA 0614 from Thor Chemie), 0.15 parts by weight of neutralizer 2-amino-2-methyl-1-propyl alcohol (AMP 95 from Dow Chemical) and the mixture of 0.50 parts by weight of deionized water and 0.50 parts by weight of thickener (Acrysol TT-615 from Dow Chemical) were blended into the mixture at a shearing rate of 1300 rpm for 30 min until fully dispersed to generate the coating composition.

The composition of Example 1 is summarized in Table 2 below.

TABLE 2

| | | | | Dosage % |
|---|---|---|---|---|
| Supplier | Trade Name | Chemical Component | Function | by weight |
| | Deionized Water | H2O | Solvent | 20.40% |
| Archroma | Mowilith ® DN 7070 | Water-borne | Binder | 45.15% |
| | | Copolymerisate | | |
| | | Dispersion plasticizer | | |
| | | free, based on (Meth) | | |
| | | Acrylic acid esters | | |
| Evonik | TEGO ® FOAMEX 810 | Octamethyl | Defoamer | 0.15% |
| | | cyclotetrasiloxane, | | |
| | | CAS-No.: 556-67-2 | | |
| Evonik | Surfynol DF-110D | Acetylenic Diol | Defoamer | 0.15% |
| BYK | DISPERBYK-190 | Solution of a high | Dispersant | 0.30% |
| | | molecular weight block | | |
| | | copolymer with | | |
| | | pigment affinic groups | | |
| Dow | AMP-95 ™ | 2-Amino-2-methyl-1- | Neutralizing | 0.15% |
| | | propanol, CAS-No.: | agent | |
| | | 124-68-5 | | |
| Evonik | ACEMATT ® TS 100 | Silicon dioxide | Matting | 1.13% |
| Grace | SYLOSIV ® A 3 | Zeolite | Absorber | 4.72% |
| Grace | SYLOID ® W 300 | Silicon dioxide | Matting | 5.83% |
| Clariant | Ceridust ® 8090 VITA | Polysaccharide | Matting | 2.71% |
| | | polymer, CAS-No.: | | |
| | | 9004-34-6 | | |
| Dow | DPnB | Di(propylene glycol) | Film-former | 2.26% |
| | | butyl ether, mixture of | | |
| | | isomers | | |
| THOR | ACTICIDER LA 0614 | Combination of | Biocide | 0.20% |
| | | CIT/MIT and Bronopol | | |
| Dow | ACRYSOL ™ TT-615 | Acrylic based alkali | Thickener | 0.50% |
| | | soluble emulsion | | |
| | | thickener | | |
| Heubach | Colanyl White TQ 100-CN | Titanium dioxide | Pigment | 15.00% |
| | | dispersion | | |
| Lyondellbasell | 1,2-Propanediol | CAS-No.: 57-55-6 | Humectant | 1.35% |
| | | | | 100.00% |

The coating compositions according to Examples 2 to 5 were prepared accordingly.

The components blended in the compositions of Examples 1 to 5 are summarized in Table 3 below.

TABLE 3

| Function | Component | Ex. 1 | Ex. 2 | Ex. 3 | Ex. 4 | Ex. 5 |
|---|---|---|---|---|---|---|
| Binder | Mowilith DN 7070 | 30.10 | 30.10 | 30.10 | 30.10 | 28.60 |
| Pigment | Colanyl White TQ 100-CN | 15.00 | 15.00 | 15.00 | | 20.00 |
| Pigment | Colanyl White R 500 | | | | 15.00 | |
| Defoamer | TEGO ® FOAMEX 810 | 0.15 | 0.15 | 0.15 | 0.15 | 0.15 |
| Dispersant | DISPERBYK-190 | 0.30 | 0.30 | 0.30 | 0.30 | 0.30 |
| Humectant | 1,2-Propanediol | 1.35 | — | 1.30 | 1.35 | — |
| Matting | ACEMATT ® TS 100 | 1.13 | 1.07 | 1.07 | 1.13 | 1.07 |
| Molecular | SYLOSIV A 3 | 4.72 | 4.48 | 4.48 | 4.72 | 4.48 |
| sieve | | | | | | |
| Matting | Ceridust 8090 VITA | 2.71 | 2.57 | 2.57 | 2.71 | 2.57 |
| Matting | SYLOID W 300 | 5.83 | 5.54 | 5.54 | 5.83 | 5.54 |
| Solvent | DI Water | 1.85 | 1.85 | 1.85 | 1.85 | 1.76 |
| Binder | Mowilith DN 7070 | 15.05 | 15.05 | 15.05 | 15.05 | 14.30 |
| Solvent | The mixture of DI water | 18.05 | 20.13 | 18.83 | 18.05 | 17.58 |
| Film-former | DPnB | 2.26 | 2.26 | 2.26 | 2.26 | 2.15 |
| Defoamer | Surfynol DF-110D | 0.15 | 0.15 | 0.15 | 0.15 | 0.15 |
| Biocide | ACTICIDE ® LA 0614 | 0.20 | 0.20 | 0.20 | 0.20 | 0.20 |
| Neutralizer | AMP 95 | 0.15 | 0.15 | 0.15 | 0.15 | 0.15 |
| Solvent | The mixture of DI water | 0.50 | 0.50 | 0.50 | 0.50 | 0.50 |
| Thickener | ACRYSOL ™ TT615 | 0.50 | 0.50 | 0.50 | 0.50 | 0.50 |
| Total | | 100.00 | 100.00 | 100.00 | 100.00 | 100.00 |

The coating composition was sprayed onto a cement-fibre board with an amount of 150 g/m³ and cured in an oven with a temperature at 200° C. for 3 min to form the colour imaging layer. The cement-fibre board was pre-treated with a sealing coating.

### Performance Evaluation:

Status in container:
No hard block, uniform after mixing.

### Evaluation Criteria:

A: qualified
B: unqualified

### Freeze Thaw Stability:

According to GB/T9268-2008: put the sample tank into the freezer, keep the temperature at −5±2° C., and leave a gap of at least 25 mm between adjacent sample tanks and between the sample tank and the tank wall. The sample tank shall be taken out after being placed in the refrigerator for 18 h, and then placed for 6 h at 23±2° C. for one cycle, no deterioration after 3 cycles, no deterioration such as hard block, flocculation and water stratification.

### Evaluation Criteria:

A: qualified
B: unqualified

### Drying Time:

According to table B method in GB/T 1728-1979 standard: touch the surface of the paint film gently with your fingers. If you feel some sticky but no paint sticks to your fingers, it is considered that the surface is dry.

### Evaluation Criteria:

within 2 h of surface drying.

### Adhesion:

According to GB/T 9286 standard: use a single edge cutter to cut 3 parallel passes along the parallel and vertical directions of the long side of the plate, the interval of each pass is 3 mm, and the number of grids is 4. Conduct the tape tear off test. Observe the test surface, there is coating peeling at the intersection of the Notch/or along the edge of the notch. The affected cross cutting area is obviously less than 15%, that is, the test result grade is ≤grade 2

### Evaluation Criteria:

(0) The edges of the cuts are completely smooth; none of the squares of the lattice is detached.
(1) Detachment of small flakes of the coating at the intersections of the cuts. A cross-cut area not greater than 5% is affected.
(2) The coating has flaked along the edges and/or at the intersections of the cuts. A cross-cut area greater than 5%, but not greater than 15%, is affected.
(3) The coating has flaked along the edges of the cuts partly or wholly in large ribbons, and/or it has flaked partly or wholly on different parts of the squares. A cross-cut area greater than 15%. but not greater than 35%, is affected.
(4) The coating has flaked along the edges of the cuts partly or wholly in large ribbons, and/or it has flaked partly or wholly on different parts of the squares. A cross-cut area greater than 35%. but not greater than 65%, is affected.
(5) Any degree of flaking that cannot even be classified by classification 4.

### Color Performance:

The obtained building boards were arranged under an inkjet apparatus equipped with four colors of water-based inks, namely, Cyan, Magenta, Yellow and Black. The ejection and suspension of four inks from nozzle is individually controlled by a control unit. Inkjet printing was carried out by directly printing pre-designed images on the building boards. Then the building boards were dried in an oven with a temperature of 200° C. for 3 min to cure the imaging layer. Preferably, a transparent top coating is sprayed onto the cured imaging layer for protection. The obtained images are visually evaluated.

### Evaluation Criteria:

Colour strength from 1 (very low) to 5 (high)
Resolution from 1 (very blurry and dull, image is difficult to recognize) to 5 (images clean and clear).

The results of the performance evaluations are summarized in Table 4 below.

TABLE 4

| | Ex. 1 | Ex. 2 | Ex. 3 | Ex. 4 | Ex. 5 |
|---|---|---|---|---|---|
| Status in Container | A | A | A | A | A |
| Freeze Thaw Stability | A | A | A | A | A |
| Drying Time [h] | ≤2 | ≤1 | ≤2 | ≤2 | ≤1 |
| Adhesion | 2 | 2 | 2 | 2 | 2 |
| Color Performance | 5 | 4 | 4 | 4 | 3 |
| (Colour Strength) | | | | | |
| Color Performance | 5 | 4 | 4 | 3 | 3 |
| (Resolution) | | | | | |

1. A method for the preparation of a coated building board comprising an ink receiving layer, the method comprising at least
i) application of an aqueous coating composition comprising
a) 5 to 40% by weight of the coating composition of an acrylic polymer,
b) 1 to 6% by weight of the coating composition of a molecular sieve, and
c) 1 to 30% by weight of the coating composition of a pigment,
on at least a part of the surface of the building board, and
ii) curing the coating composition.

2. The method of claim 1, wherein the surface of the building board on which the aqueous coating composition is applied does not contain a coloured primer layer.

3. The method of claim 1 or 2, wherein the surface of the building board on which the aqueous coating composition is applied contains a sealing layer.

4. The method of any one of claims 1 to 3, wherein the molecular sieve is a microporous molecular sieve, preferably selected from the group consisting of zeolites.

5. The method of any one of claims 1 to 4, wherein the at least 90% of the pores of the molecular sieve has pore diameters between 0.1 nm and 2 nm, preferably the molecular sieve is a 3 Å, 4 Å or 5 Å zeolite.

6. The method of any one of claims 1 to 5, wherein the acrylic polymer comprises an acrylic polymer obtainable by free radical polymerization of an acrylic monomer composition, wherein the acrylic monomers are selected from the group consisting of acrylate, methacrylate, alkyl acrylate, alkyl methacrylate, hydroxyalkyl acrylate, hydroxyalkyl methacrylate, epoxyalkyl acrylate, epoxyalkyl methacrylate, acrylonitrile, methacrylonitrile, acrylamide, methacrylamide, acrylic acid and mixtures thereof and optionally ethylenically unsaturated comonomers.

7. The method of any one of claims 1 to 6, wherein the pigment is selected from the group consisting of titanium dioxide, zinc oxide, zinc sulphide, barium sulfate, lead white, antimony white, calcium carbonate and lithopone.

8. The method of any one of claims 1 to 7, wherein the aqueous coating composition comprises at least one additive selected from the group consisting of film-former, dispersants, thickeners, defoamer, neutralizer, biocides, matting agents and humectants.

9. The method of any one of claims 1 to 8, wherein the aqueous coating composition comprises a matting agent.

10. The method of claim 9, wherein the matting agent comprises at least one of silicon dioxide and wax powder.

11. The method of any one of claims 1 to 10, wherein the aqueous coating composition comprises a humectant.

12. The method of any one of claims 1 to 11, wherein the aqueous coating composition comprises a film former.

13. An aqueous coating composition as defined in any one of claims 1 to 12 comprising
a) 5 to 40% by weight of an acrylic polymer,
b) 1 to 6% by weight of a molecular sieve, and
c) 1 to 30% by weight of a pigment.

14. The aqueous coating composition of claim 13 comprising
a) 5 to 40% by weight of an acrylic polymer,
b) 1 to 6% by weight of a molecular sieve,
c) 1 to 30% by weight of a pigment,
d) optionally 0 to 2% by weight of a defoamer,
e) optionally 0 to 2% by weight of a dispersant or wetting agent,
f) optionally 0 to 15% by weight of a matting agent,
g) optionally 0 to 10% by weight of a film former,
h) optionally 0 to 2% by weight of a thickener,
i) optionally 0 to 1% by weight of a biocide,
j) optionally 0 to 1% by weight of a neutralizer, and
k) optionally 0 to 5% by weight of a humectant.

15. The aqueous coating composition of claim 14 comprising
a) 10 to 35% by weight of an acrylic polymer,
b) 2 to 5.5% by weight of a molecular sieve,
c) 2.5 to 25% by weight of a pigment,
d) 0.1 to 2% by weight of a defoamer,
e) 0.1 to 2% by weight of a dispersant or wetting agent,
f) 0.1 to 15% by weight of a matting agent,
g) 0.1 to 10% by weight of a film former,
h) 0.1 to 2% by weight of a thickener,
i) 0.05 to 1% by weight of a biocide,
j) 0.05 to 1% by weight of a neutralizer, and
k) 0.1 to 5% by weight of a humectant.

16. A coated building board comprising an ink receiving layer of a cured coating composition of one of claims 1 to 15 on at least a part of the surface of the building board.

17. The coated building board of claim 16, wherein the building board is a cement plate, gypsum plate, ceramic plate, metal plate, wooden plate, polymer resin plate, calcium silicate plate, diatomite plate and polystyrene plate.

18. Use of a building board of any one of claims 16 and 17 as base material for inkjet printing with water-based ink.

19. The use of an aqueous coating composition as defined in one of claims 1 to 15 for preparing an ink receiving layer on a building board used as base material for inkjet printing with water-based ink.

20. The use of claim 19, wherein the aqueous coating composition is applied to a surface of the building board that does not contain a coloured primer layer.
